(19) United States
(12) Patent Application Publication
(10) Pub. No.: US 2019/0161184 A1
(43) Pub. Date: May 30, 2019

(54) BIMODAL EMERGENCY RESPONSE ROBOTS

(71) Applicants: Aiman Arshad, Dubai (AE); Salman Badshah, Dubai (AE)

(72) Inventors: Aiman Arshad, Dubai (AE); Salman Badshah, Dubai (AE)

(21) Appl. No.: 16/199,293

(22) Filed: Nov. 26, 2018

Related U.S. Application Data
(60) Provisional application No. 62/590,534, filed on Nov. 25, 2017.

(51) Int. Cl. B64C 37/00; G05D 1/00; B64C 39/02; B60F 5/02; A62B 99/00; B25J 9/00; B25J 13/00; B25J 5/00

(52) U.S. Cl. CPC B64C 37/00; G05D 1/0016; B64C 39/024; B25J 5/007; A62B 99/00; B25J 9/0009; B25J 13/006; B60F 5/02

(57) ABSTRACT

A bimodal robot operable in a ground mode and a flight mode, the bimodal robot including: a frame; a ground unit including a plurality of wheels located on a lower portion of the frame and one or more arms mounted on the frame; a flight unit including a plurality of flight motors and propellers attached thereto, the flight unit located on an upper portion of the frame; a master controller in wireless communication with a remote, the master controller in communication with a ground unit slave controller for controlling the plurality of wheels during operation of the bimodal robot in a ground mode and one or more arms of the ground unit and a flight unit slave controller for controlling the plurality of flight motors during operation of the bimodal robot in a flight mode.

### CROSS-REFERENCE TO RELATED APPLICATION

This application claims priority to and is a non provisional of U.S. Provisional Patent Application Ser. No. 62/590,534 for “Bimodal Emergency Response Robots” filed on Nov. 25, 2018, the contents of which are incorporated herein by reference in its entirety.

### FIELD

This disclosure relates to the field of bimodal robots. More particularly, this disclosure relates to autonomously or remotely controlled robots which are capable of both aerial and terrestrial locomotion and are equipped to interact with a surrounding environment.

### BACKGROUND

The field of robotics—specifically, of unmanned mechanical devices—has increasingly played a significant role in modern society. An unmanned vehicle such as a rover or drone, which may also be referred to as an autonomous vehicle, is a vehicle capable of travel without a physically-present human operator. These machines may operate in a remote-control mode, in an autonomous mode, or in a partially autonomous mode. When an unmanned vehicle operates in a remote-control mode, a pilot or driver that is at a remote location can control the unmanned vehicle via commands that are sent to the unmanned vehicle via a wireless link. When the unmanned vehicle operates in autonomous mode, the unmanned vehicle typically moves based on pre-programmed navigation waypoints, dynamic automation systems, or a combination of these. Further, some unmanned vehicles can operate in both a remote-control mode and an autonomous mode, and in some instances, may do so simultaneously. For instance, a remote pilot or driver may wish to leave navigation to an autonomous system while manually performing another task, such as operating a mechanical system for picking up objects, as an example.

Several research endeavors within the healthcare sector have been directed to the advancement of robotic rovers. One of the more prominent robots of such kind is TUG, a robotic rover equipped with autonomous navigation designed to assist in hospital facilities by delivering goods from one location to another. These robots are primarily terrestrial navigators which utilize various methods of locomotion, such as by incorporating wheels or tracks. More recently, a growing area of research has sought to combine robotic rovers with arm manipulator(s). Robots like AILA demonstrate a vast range of functionality, as a variety of actions can be performed via incorporation of arm manipulators with rover technology.

Another growing field of research concerns ambulatory drone technology. These robots are capable of quickly reaching isolated or otherwise inaccessible locations, making them particularly valuable in emergency response situations where timely provision of care can make a significant difference in the outcome of a patient's health.

While the above research endeavors demonstrate potential and progress in the field of robot-assisted healthcare, traditional ambulatory emergency responses (e.g., by ambulance and emergency response teams) remain the status quo in situations such as natural disasters, accidents, etc. In addition to the fact that traditional response times are often much slower than necessary, direct ambulatory care can also subject the response team to eminent danger, potentially harming even more individuals in the process of rescuing or assisting a person in need of help. Currently available emergency response equipment is ill-suited to provide a sufficient response to the growing number of catastrophic situations.

Moreover, although robotic technology has advanced greatly in recent years, many people still find the process of learning to use or control rovers and drones to be cumbersome and unnatural, presenting a natural aversion to utilizing the machines. This can be particularly relevant for flying robots, as many of the drones currently available on the market fail to incorporate adequate measures to prevent damage to the machine in the event of a hard landing.

What is needed, therefore, is wireless robotic emergency response technology with sufficient operability and simplicity to displace the traditional methods via incorporation of rover, drone, and arm manipulator elements as comprehensive tools, thereby enabling a response in any emergency situation, regardless of geographical accessibility.

### SUMMARY

The following summary describes features of the various embodiments of the invention. It is not intended to limit the description of the invention in any way.

The disclosed improvements form an apparatus that satisfies the need for a better emergency response robot. The apparatus generally constitutes a wireless robot having a ground unit which includes a robotic rover and arm manipulators, a flight unit including a multi-rotor drone (such as a quadcopter), and a software application constituting a user interface.

In a first aspect, a bimodal robot is operable in a ground mode and a flight mode and includes: a frame; a ground unit including a plurality of wheels located on a lower portion of the frame and one or more arms mounted on the frame; a flight unit including a plurality of flight motors and propellers attached thereto, the flight unit located on an upper portion of the frame; a master controller in wireless communication with a remote, the master controller in communication with a ground unit slave controller for controlling the plurality of wheels during operation of the bimodal robot in a ground mode and one or more arms of the ground unit and a flight unit slave controller for controlling the plurality of flight motors during operation of the bimodal robot in a flight mode.

In one embodiment, the frame further includes an upper deck and a lower deck. The one or more arms and plurality of flight motors are mounted on the upper deck and wherein the plurality of wheels are mounted on the lower deck.

In another embodiment, the bimodal robot further includes a plurality of wheel brackets pivotally attached to the lower deck, the plurality of wheel brackets securing the plurality of wheels to the lower deck. In yet another embodiment, the bimodal robot further includes a plurality of shock absorption devices attached between the plurality of wheels and the upper deck of the frame.

In one embodiment, the bimodal robot further includes a wireless controller in communication with the master controller. In another embodiment, in the ground mode a plurality of ground controls are displayed on the wireless controller and in the flight mode a plurality of flight controls are displayed on the wireless controller.

In a second aspect, a bimodal robot operable in a ground mode and a flight mode includes: a frame having an upper deck and a lower deck; a ground unit including a plurality of wheels located on the lower deck of the frame and one or more arms mounted on the upper deck of the frame; a flight unit including a plurality of flight motors and propellers attached thereto, the flight unit located on the upper deck of the frame; a master controller in wireless communication with a remote, the master controller in communication with a ground unit slave controller for controlling the plurality of wheels during operation of the bimodal robot in a ground mode and one or more arms of the ground unit and a flight unit slave controller for controlling the plurality of flight motors during operation of the bimodal robot in a flight mode.

In one embodiment, the bimodal robot further includes a plurality of wheel brackets pivotally attached to the lower deck, the plurality of wheel brackets securing the plurality of wheels to the lower deck.

In another embodiment, the bimodal robot further includes a wireless controller in communication with the master controller. In yet another embodiment, in the ground mode a plurality of ground controls are displayed on the wireless controller and wherein in the flight mode a plurality of flight controls are displayed on the wireless controller.

In a third aspect, a bimodal robot operable in a flight mode and a ground mode includes: ground components including a plurality of wheels, one or more robotic arms, and a ground component controller attached to a frame of the bimodal robot; flight components including a plurality of flight motors and propellers attached thereto and a flight component controller attached to a frame of the bimodal robot; a master controller in electronic communication with each of the ground component controller and the flight component controller. In a ground operation mode the master controller communicates with the ground component controller to operate the plurality of wheels and one or more robotic arms. In a flight operation mode the master controller communicates with the flight component controller to operate the plurality of flight motors.

In one embodiment, the bimodal robot further includes a remote in wireless communication with the master controller, wherein in the ground operation mode controls of the remote operate the ground components of the bimodal robot, and wherein in the flight operation mode controls of the remote operate the flight components of the bimodal robot.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a front elevation view of one embodiment of the apparatus;

FIG. 2 shows one embodiment of the block schematics of the hardware of the apparatus;

FIG. 3 shows one embodiment of the block schematics of the hardware of the ground unit;

FIG. 4 shows one embodiment of the structural components of the ground unit;

FIG. 5 shows one embodiment of the structural components of the arm manipulator(s);

FIG. 6 shows one embodiment of the block schematics of the hardware of the flight unit;

FIG. 7 shows a diagram of comparative rotor speeds for various movements;

FIG. 8 shows a software simulation of projected flight times;

FIG. 9 shows an image of a live feed captured by the camera mounted on the apparatus, as received on a separate device;

FIG. 10a shows a diagram representing one form of communication between the user interface and the robot;

FIG. 10b shows a diagram representing another form of communication between the user interface and the robot;

FIG. 11a shows a screen capture representing one embodiment of the software application user interface; and

FIG. 11b shows a screen capture representing another embodiment of the software application user interface.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

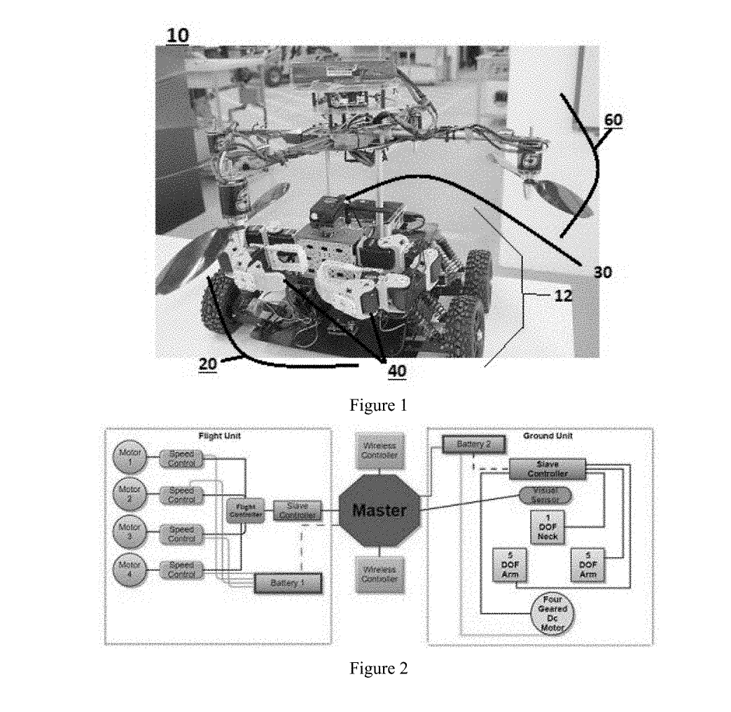

FIG. 1 shows one embodiment of the bimodal ambulatory robot 10 (hereinafter, the “Robot”). The Robot 10 has a ground unit 12 which includes a rover 20, a mounted camera 30, and at least one robotic arm 40, as well as a flight unit 60 which further constitutes a multi-rotor flight vehicle, such as a quadcopter. FIG. 2 diagrams the mechanisms of communication and relationships between the physical components of the Robot 10.

In a preferred embodiment, the ground unit 12 has a double-decked platform: The lower deck houses the components of the rover while the upper deck houses the Robot's torso, arm(s) 40, and flight unit 60. Additionally, the ground unit 12 may be made from aluminum or other similarly strong, lightweight materials. As seen in FIG. 1, the ground unit 12 is mobilized by the presence of two or more wheels; each of the wheels and the camera has at least one degree of freedom. Moreover, the ground unit 12 further incorporates a camera 30 with a wireless transmission module for aiding wireless navigation and surveillance, the camera 30 being positioned on a swivel having one or more degrees of freedom.

To maximize torque-to-weight ratio, in a preferred embodiment the wheels may be motorized via incorporation of geared DC motors; however, it is understood that servo motors, stepper motors, or other similar mechanisms as understood by one skilled in the art may also be used. Furthermore, to ensure the safety of the electronics on board during take-off and landing, a dynamic chassis may be incorporated by installing one or more shock absorbers at each wheel, between the two decks of the ground unit 12. By connecting one end of the shock absorber to the wheel bracket and the other end to a shock absorber strip underneath the upper deck, the shock absorber has room for maximum compression and expansion, thereby cancelling the impact caused by take-off and landing.

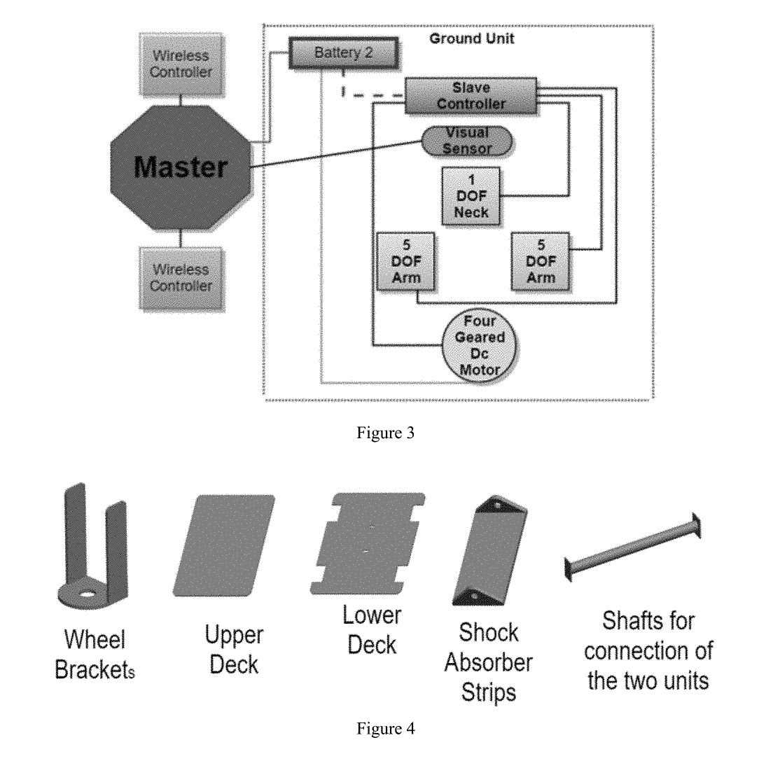

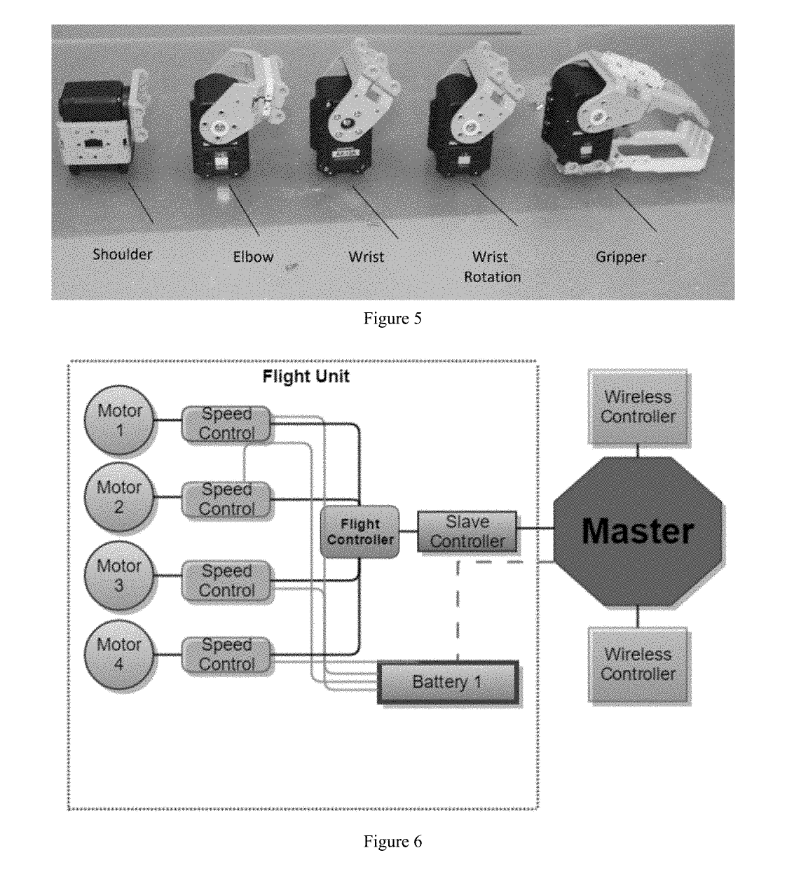

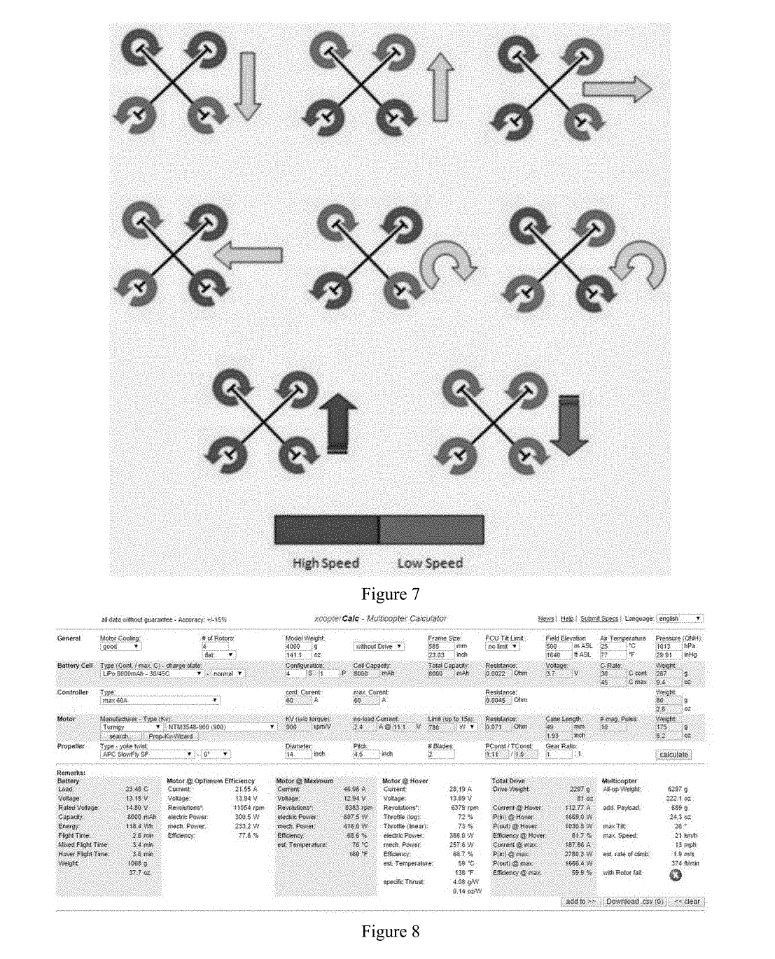

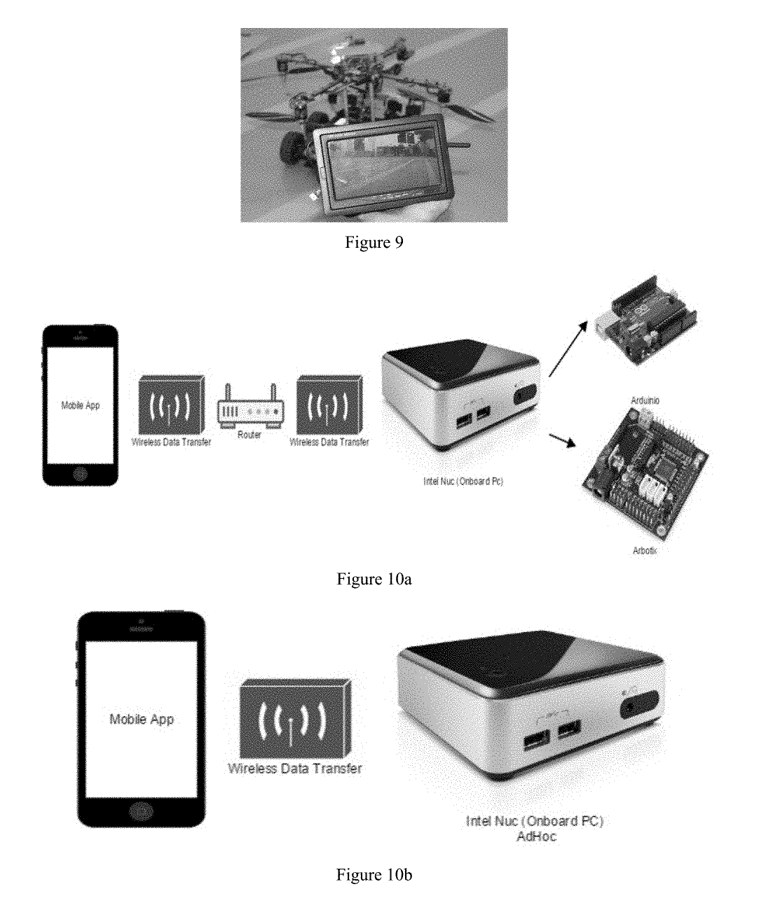

As seen in FIGS. 3 and 5, the arm(s) 40 have five or more degrees of freedom, one for each motor (found in the shoulder, elbow, wrist, wrist rotator, and gripper). Incorporation of these elements into the arm(s) 40 provides greater flexibility and range of motion, facilitating the interaction between the Robot 10 and the surrounding environment.

In a preferred embodiment, the flight unit 60 is also made of an aluminum frame, again seeking to implement a lightweight yet rigid structure. The flight unit 60 incorporates a quadcopter which may include four brushless motors and propellers made of carbon fiber or similarly resilient, lightweight composite materials. Furthermore, an electronic speed controller (ESC) is connected to each motor, regulating the speed of each motor via conversion of direct current (DC) to a controlled amount of alternating current (AC). To maintain an optimized flight, a flight controller board is coupled to an Arduino microcontroller which is the slave controller depicted in FIGS. 2 & 6. This board processes the data received from the Arduino accordingly for maintaining a stable flight.

In a preferred embodiment, the rover 20, arm(s) 40, and flight unit 60 each are regulated via individual microcontrollers routed to the communication (COM) ports present on the master controller (computer). This arrangement enables software synchronization between the ground unit 12 and flight unit 60. The master controller further establishes communication with the outside world through a software application which constitutes the user interface. In one embodiment, the Robot 10 may be powered by one or more batteries, such as two Lithium polymer batteries: a 3S 3700 mAh 25C for the rover 20 and a 4S 8000 mAh 45C for the flight unit 60.

The Robot 10 further includes a computer which, in one embodiment, is powered by a step-up voltage regulator, which steps up the voltage supplied by the one or more batteries from 11.1V to 19.8V—the voltage required by the computer. This voltage regulator acts as a safety circuit as well filtering all the voltage spikes received through the battery. The two microcontrollers installed on the rover have inbuilt voltage regulators, ensuring safe operation of the electronics without exceeding their maximum voltage and current values. On the other hand, the electronic speed controllers (ESC) on the quadcopter act as power supplies with inbuilt safety parameters managing controlled current supply to the brushless DC motors. The ESCs are also responsible for stepping down voltage supplied by the one or more batteries to power the flight controller board. The digital servo of the arms and the geared DC motors that are used to motorize the wheels of the rover are controlled and powered through microcontrollers which are in turn being powered through the one or more batteries.

The microcontrollers may be connected to the computer through standard USB ports for data transmission. The two main power wires connected to the one or more batteries are distributing equal voltage and sufficient current to the electronics and the computer through the parallel distribution of power amongst them.

In a preferred embodiment, an Arduino based microcontroller with a stacked motorshield controls the four-high torque DC geared motors. This microcontroller may be connected to one of the USB ports of the computer and follow a communication protocol to transfer data. Additionally, a controller may also be connected to the computer and used to control the digital servos of the dual arm(s) 40 using a communication protocol. The computer simultaneously receives commands from the two COM ports and transfers data wirelessly over the internet to the android application user interface.

In a preferred embodiment, a flight controller board with a 3-axis accelerometer and a 2-axis gyroscope, for example KK2.1.5, may be employed to maintain proper orientation and balance by processing the yaw, pitch and roll values produced due to the positioning of the quadcopter throughout operation. Moreover, the flight controller board may be connected to a microcontroller which acts as an intermediate between the computer and the flight controller. In a preferred embodiment, a fast firmware with an extended amount of control may be flashed onto the EPROM of the ECSs, thereby ensuring a shorter reaction time and thus providing greater stability to the quadcopter. Additionally, an onboard computer, such as a fourth generation Intel NUC computer or a raspberry pi, may be used to assist in the simultaneous control of the ground unit 12 and flight unit 60.

In a preferred embodiment, the user interface for both the ground unit 12 and flight unit 60 is software application which wirelessly connects to the PC/master controller and enables wireless control of the Robot 10. A serial communication between the three microcontrollers and the computer is established to ensure co-occurring communication. An intermediate software program running on the computer helps in receiving transmitted commands from the user interface, and forwards those commands to different target COM ports of the computer.

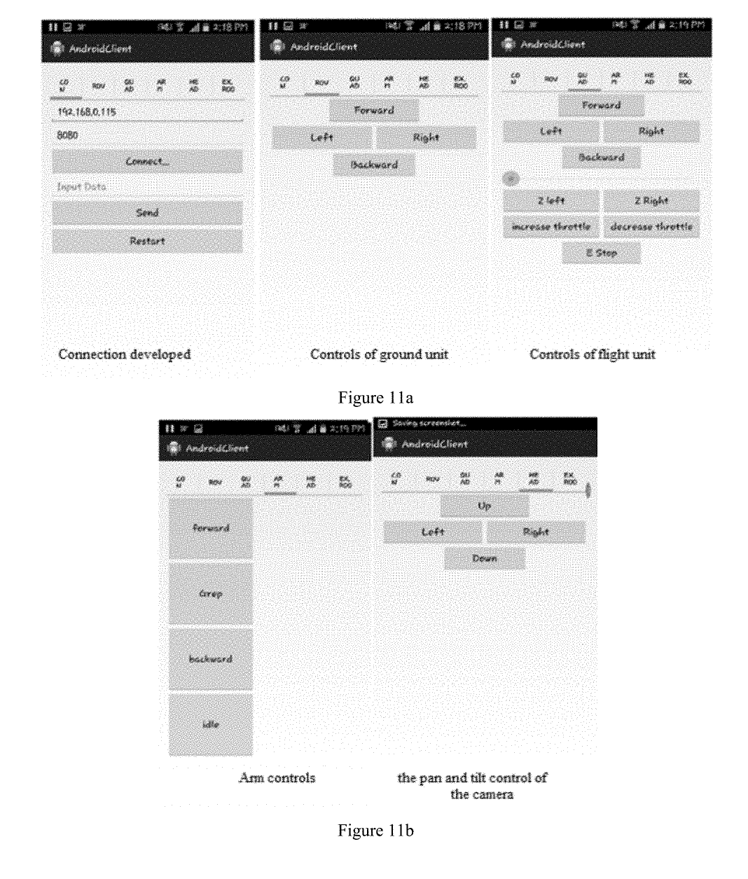

In various embodiments, the Robot 10 may handle different types of communication between the PC and android application. For example, as depicted in FIG. 10a, the Robot 10 may communicate wirelessly through a router wherein the router acts as the Wi-Fi generator and the range of communication depends on the availability of internet through Wi-Fi or cellular towers in the vicinity. FIG. 2, demonstrates a schematic of the aforementioned communication protocol. As depicted in FIG. 10b, the Ad-Hoc technique of communication may be useful, such as where internet may not be available. In this Ad-Hoc technique, the PC acts as a self-generating Wi-Fi device and thus transfers data to the mobile application wirelessly over a limited range.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A bimodal robot operable in a ground mode and a flight mode, the bimodal robot comprising:
a frame;
a ground unit including a plurality of wheels located on a lower portion of the frame and one or more arms mounted on the frame;
a flight unit including a plurality of flight motors and propellers attached thereto, the flight unit located on an upper portion of the frame;
a master controller in wireless communication with a remote, the master controller in communication with a ground unit slave controller for controlling the plurality of wheels during operation of the bimodal robot in a ground mode and one or more arms of the ground unit and a flight unit slave controller for controlling the plurality of flight motors during operation of the bimodal robot in a flight mode.

2. The bimodal robot of claim 1, the frame further comprising an upper deck and a lower deck, wherein the one or more arms and plurality of flight motors are mounted on the upper deck and wherein the plurality of wheels are mounted on the lower deck.

3. The bimodal robot of claim 2, further comprising a plurality of wheel brackets pivotally attached to the lower deck, the plurality of wheel brackets securing the plurality of wheels to the lower deck.

4. The bimodal robot of claim 3, further comprising a plurality of shock absorption devices attached between the plurality of wheels and the upper deck of the frame.

5. The bimodal robot of claim 1, further comprising a wireless controller in communication with the master controller.

6. The bimodal robot of claim 5, wherein in the ground mode a plurality of ground controls are displayed on the wireless controller and wherein in the flight mode a plurality of flight controls are displayed on the wireless controller.

7. A bimodal robot operable in a ground mode and a flight mode, the bimodal robot comprising:
a frame having an upper deck and a lower deck;
a ground unit including a plurality of wheels located on the lower deck of the frame and one or more arms mounted on the upper deck of the frame;
a flight unit including a plurality of flight motors and propellers attached thereto, the flight unit located on the upper deck of the frame;
a master controller in wireless communication with a remote, the master controller in communication with a ground unit slave controller for controlling the plurality of wheels during operation of the bimodal robot in a ground mode and one or more arms of the ground unit and a flight unit slave controller for controlling the plurality of flight motors during operation of the bimodal robot in a flight mode.

8. The bimodal robot of claim 7, further comprising a plurality of wheel brackets pivotally attached to the lower deck, the plurality of wheel brackets securing the plurality of wheels to the lower deck.

9. The bimodal robot of claim 1, further comprising a wireless controller in communication with the master controller.

10. The bimodal robot of claim 9, wherein in the ground mode a plurality of ground controls are displayed on the wireless controller and wherein in the flight mode a plurality of flight controls are displayed on the wireless controller.

11. A bimodal robot operable in a flight mode and a ground mode, the bimodal robot comprising:
ground components including a plurality of wheels, one or more robotic arms, and a ground component controller attached to a frame of the bimodal robot;
flight components including a plurality of flight motors and propellers attached thereto and a flight component controller attached to a frame of the bimodal robot;
a master controller in electronic communication with each of the ground component controller and the flight component controller;
wherein in a ground operation mode the master controller communicates with the ground component controller to operate the plurality of wheels and one or more robotic arms; and
wherein in a flight operation mode the master controller communicates with the flight component controller to operate the plurality of flight motors.

12. The bimodal robot of claim 11, further comprising a remote in wireless communication with the master controller, wherein in the ground operation mode controls of the remote operate the ground components of the bimodal robot, and wherein in the flight operation mode controls of the remote operate the flight components of the bimodal robot.
